(19) United States
(12) Patent Application Publication
(10) Pub. No.: US 2006/0078244 A1
(43) Pub. Date: Apr. 13, 2006

(54) Hybrid bearing

(75) Inventors: Joon Keun Lee, Seoul (KR); Chang Joung Lee, Suwon-si (KR); Jun Ho Kim, Gunpo-si (KR)

Correspondence Address: COOPER & DUNHAM, LLP, 1185 AVENUE OF THE AMERICAS, NEW YORK, NY, 10036, US

(73) Assignee: LG CABLE LTD.

(21) Appl. No.: 11/158,351

(22) Filed: Jun. 16, 2005

(30) Foreign Application Priority Data
Oct. 11, 2004 (KR) 2004-81038

(51) Int. Cl. F16C 32/06; F16C 27/00

(52) U.S. Cl. 384/535

(57) ABSTRACT

The present invention relates to a hybrid bearing, and more particularly to a bearing structure in which ceramic balls are used to reduce friction of a rotating shalt during high-speed and low-speed rotation of the rotating shall, and a corrugated elastic plate, formed through multiple bending, is provided abut against the outer circumference of the outer ring of a bearing in order to absorb shock applied to the ceramic balls, thereby eliminating the need to supply lubrication oil.

### BACKGROUND OF THE INVENTION

1. Field of the Invention

The present invention relates to a hybrid bearing, and more particularly to a bearing structure in which ceramic balls are used to reduce friction of a rotating shaft during high-speed and low-speed rotation of the rotating shaft, and a corrugated elastic plate, formed through multiple bending, is provided abut against the outer circumference of the outer ring of a bearing in order to absorb shock applied to the ceramic balls, thereby eliminating the need to supply lubrication oil.

2. Description of the Related Art

In general, bearings are mechanical elements to maintain rotating shafts of machines at their original positions and to allow smooth rotation of the shafts while bearing the weight of the shafts and other load acting on the shafts.

The bearings are classified into rolling bearings and sliding bearings, on the basis of how they come into contact with the rotating shafts.

In the case of the rolling bearings, the balls rotate between the outer and inner rings of the bearings by rotation of the shafts, causing frictional heat and vibration.

Thereby, the rolling bearings have a difficulty to be applied to the shafts rotating at high speeds, although the use of the rolling bearings does not matter in the case of low-speed rotation.

In relation to the sliding bearings, a conventional example thereof is shown in FIG. 1. As shown in FIG. 1, the conventional sliding bearing 1 is configured so that a rotating shaft 7 is installed inside a journal bearing 5 formed with oil-delivery holes 3 and lubrication oil 9 is filled between the rotating shaft 7 and the journal bearing 5 to form a lubrication film.

The journal bearing 5, configured as mentioned above, is mounted within a housings which is formed with an oil inlet.

In order to maintain the lubrication film between the rotating shaft 7 and the journal bearing 5, the lubrication oil 9 must be continuously supplied via oil-delivery holes 3.

During operation of the sliding bearing 1, the lubrication film, formed of the lubrication oil 9 between the rotating shaft 7 and the journal bearing 5, produces a wedge force to thereby allow the rotating shaft 7 to rotate while being spaced apart from the journal bearing 5.

The sliding bearing 1, however, is troublesome in operation since it requires to continuously supply the lubrication oil 9 between the rotating shaft 7 and the journal bearing 5 during the operation-of the sliding bearing 1.

Further, the higher the rotational speed of the rotating shaft 7, the greater the relative speed of the journal bearing 5 and the rotating shaft 7, dramatically increasing the temperature of the lubrication oil 9 forming the lubrication film.

This makes the lubrication film formed by the lubrication oil 9 unstable. Upon high-speed rotation, the lubrication film may be broken.

Such a breakage of the lubrication film causes the rotating shaft 7, spaced apart from the journal bearing 5 by interposing the lubrication oil 9, to come into direct contact with the journal bearing 5, resulting in damage of the rotating shaft 7 and the journal bearing 5.

The fact that the lubrication film is made of a liquid-phase fluid, namely, lubrication oil 9, increases the breakage possibility of the lubrication film when external shock is applied thereto.

### SUMMARY OF THE INVENTION

Therefore, the present invention has been made in view of the above problems, and it is an object of the present invention to provide a hybrid bearing which is stably usable in high-speed or high-temperature conditions without the need to continuously supply lubrication oil.

In accordance with the present invention, the above and other objects can be accomplished by the provision of a hybrid bearing comprising: an inner ring fitted on the outer circumference of a rotating shaft adapted to transmit rotation power to the bearing, the inner ring rotating along with the rotating shaft; an outer ring fitted to be spaced apart from the inner ring by a predetermined distance; a retainer interposed between the inner ring and the outer ring, the retainer being mounted with a plurality of balls; an elastic member fitted to surround the outer circumference of the outer ring in order to absorb shock applied to the balls, the elastic member having a predetermined elasticity so as to be compressed or restored due to the shock applied to the balls; and a case located external to the elastic member to position the elastic member so that the elastic member comes into contact with the outer ring.

Preferably, the balls may be made of a highly heat-resistant ceramic material.

Preferably, the elastic member may be a corrugated elastic plate formed by being multiply bent to have a serpentine pattern.

Preferably, the bearing may further comprise a shock-absorbing member attached to at least one of either the inner and outer circumferences of the corrugated elastic plate.

Preferably, the case may be perforated with a plurality of vent holes to introduce cooling air to the elastic member.

According to the present invention as described above, it is unnecessary to supply lubrication oil into the bearing rotating at high speeds to thereby eliminate the need for a complex lubrication supply system including an oil pump, resulting in a reduction in manufacturing cost of the bearing and simplifying repair and management of the bearing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a conventional sliding bearing;

FIG. 2 is an exploded perspective view of a hybrid bearing according to a preferred embodiment of the present invention;

FIG. 3 is a sectional view of the hybrid bearing of FIG. 2;

FIG. 4 is an enlarged sectional view illustrating the non-compressed state of a corrugated elastic plate shown in FIG. 3;

FIG. 5 is an enlarged sectional view illustrating a compressed state-of the corrugated elastic plate; and,

FIG. 6 is an enlarged sectional view of a shock-absorbing member attached to the corrugated elastic plate according to an alternative embodiment of the present invention.

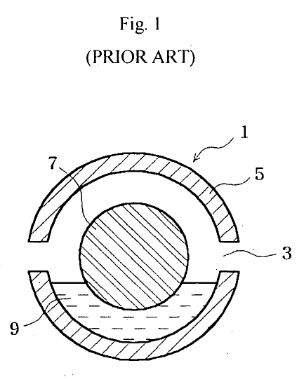

### DESCRIPTION OF THE PREFERRED EMBODIMENTS

Now, preferred embodiments of the present invention will be explained with reference to the accompanying drawings; It is to be understood that the following detailed description related to the embodiments of the present invention are exemplary and explanatory only and not restrictive of the invention, and the present invention can be implemented in numerous ways.

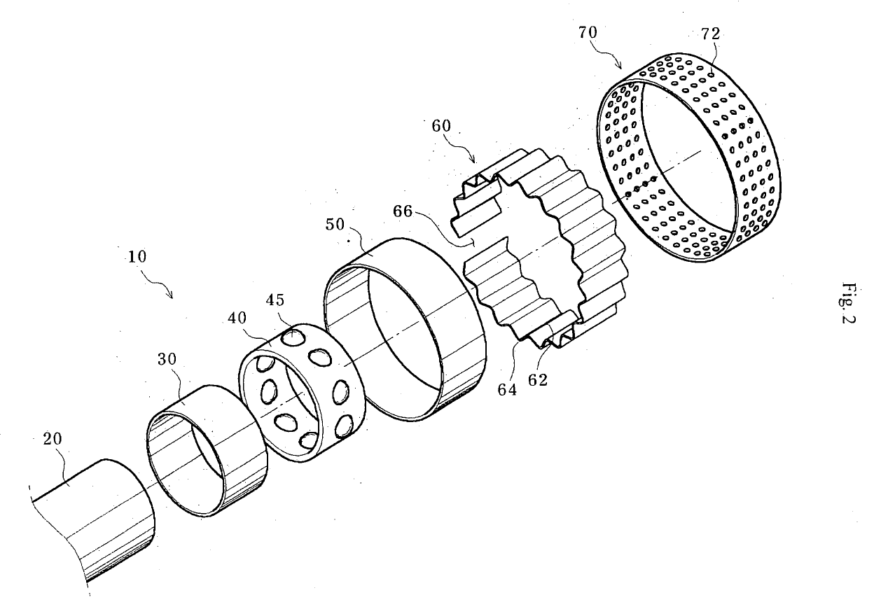

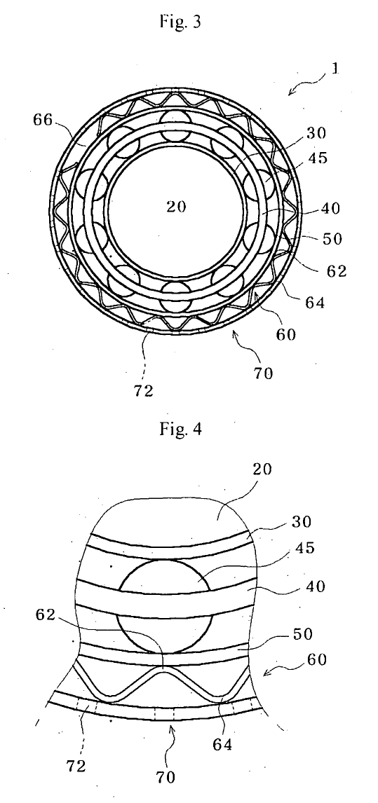

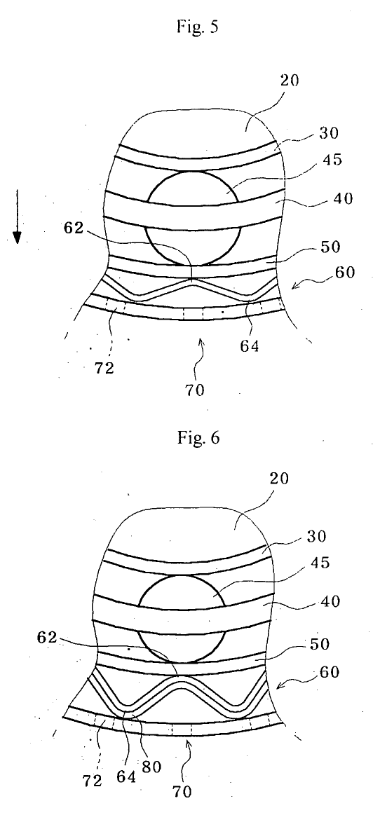

FIGS. 2 and 3 are an exploded perspective view and a sectional view, respectively, illustrating a hybrid bearing according to a preferred embodiment of the present invention. FIGS. 4 and 5 are enlarged sectional views, respectively, illustrating a non-compressed state and a compressed state of a corrugated elastic plate shown in FIG. 3. FIG. 6 is an enlarged sectional view of a shock-absorbing member attached to the corrugated elastic plate according to an alternative embodiment of the present invention.

As shown in FIGS. 2 to 6, the hybrid bearing 10 according to the present invention comprises an inner ring 30, into which a rotating shaft 20 adapted to transmit rotational power to the bearing 10 is inserted. The inner ring 30 rotates along with the rotating shalt 20.

On the outer circumference of the inner ring 30 is coupled to a retainer 40. The retainer 40 is equidistantly mounted with a plurality of balls 45 in the circumferential direction thereof.

An outer ring 50, coupled adjacent to the balls 45, has an annular band form, and is spaced apart from the inner ring 30 by a predetermined distance.

The balls 45 are preferably made of a highly heat-resistant material in order to achieve stability in operational performance thereof even if they are affected by high-temperature frictional heat caused by high-speed rotation of the bearing 10. In a preferred embodiment of the present invention, the balls 45 are made of a ceramic material.

Abutting against the outer circumference of the outer ring 50 is an elastic member, namely, a corrugated elastic plate 60. The corrugated elastic plate 60, made of an elastic material, is multiply bent to define a serpentine pattern and thus has a plurality of peaks 62 and valleys 64.

With such a configuration, the corrugated elastic plate 60 is provided with a high enough elasticity to absorb shock applied to the balls 45.

The corrugated elastic plate 60 has an open loop form to define a gap 66. The width of the gap 66 is determined to accommodate constriction or expansion of the corrugated elastic plate 60 when the corrugated elastic plate 60 is compressed or restored.

When the hybrid bearing 10 of the present invention is used to support shafts rotating at high speeds, the corrugated elastic plate 60 is formed of a thin-elastic plate in order to increase the number of bends and thus maximize a heat-emission area thereof

Finally coupled on the outer circumference of the corrugated elastic plate 60 is a case 70, which serves to position the corrugated elastic plate 60 so that the corrugated elastic plate 60 comes into contact with the outer ring 50. The case 70 is perforated with a plurality of vent holes 72 to introduce cooling air to the corrugated elastic plate 60.

As can be seen from FIG. 6 illustrating an alternative embodiment of the present invention, a shock-absorbing member 80 made of rubber, etc. is attached to the corrugated elastic plate 60 so as to absorb shock applied to the corrugated elastic plate 60.

The shock-absorbing member 80 may be attached to at least one of the inner and outer circumferences of the corrugated elastic plate 60.

Now, the operation of the hybrid bearing 10 according to the present invention will be explained.

Upon rotation of the rotating shaft 20, the inner ring 30, against the outer circumference of the rotating shaft 20, simultaneously rotates.

Thereby, the balls 45 in contact with the inner ring 30 also rotate, causing the outer ring 50 to rotate while being spaced apart from the inner ring 30 by a predetermined distance. Here, the balls 45 can endure high-temperatures generated upon high-speed rotation since they are made of a highly heat-resistant ceramic material.

If a static load or rotational vibration is applied to the hybrid bearing 10, it is absorbed by the corrugated elastic plate 60.

FIG. 4 illustrates a non-compressed original form of the corrugated elastic plate 60 before a load is applied to the balls 45, and FIG. 5 illustrates a compressed deformed state of the corrugated elastic plate 60 upon receiving the load applied to the balls 45.

The corrugated elastic plate 60 has the effect of completely preventing damage to the ceramic balls 45 having a relatively low strength, although the balls 45 are highly heat-resistant.

Further, the corrugated elastic plate 60 shows a relatively wide heat-emission area by virtue of the multiply bent configuration thereof, resulting in improved heat-emission efficiency through air cooling.

In order to improve the performance of the corrugated elastic plate 60, as shown in FIG. 6, the shock absorbing member 80, made of a viscoelastic or rubber material, is attached to at least one of the inner and outer circumferences of the corrugated elastic plate 60, thereby improving the shock-absorbing performance of the corrugated elastic plate 60.

Meanwhile, the plurality of vent holes 72 of the case 70 facilitates smooth heat-emission of the corrugated elastic plate 60.

As apparent from the above description, the present invention provides a hybrid bearing which comprises highly heat-resistant balls and a heat-emittable corrugated elastic plate, thereby being capable of achieving stable operation thereof without the need to supply lubrication oil even in a relatively high-temperature condition caused by high-speed rotation of the bearing.

Further, according to the present invention, through the use of the corrugated elastic plate having a shock-absorbing structure, it is possible to ensure stable rotation of the rotating shaft, resulting in a reduction in power.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hybrid bearing comprising:
an inner ring fitted on the outer circumference of a rotating shaft adapted to transmit rotation power to the bearing, the inner ring rotating along with the rotating shaft;
an outer ring fitted to be spaced apart from the inner ring by a predetermined distance;
a retainer interposed between the inner ring and the outer ring, the retainer being mounted with a plurality of balls;
an elastic member fitted to surround the outer circumference of the outer ring in order to absorb shock applied to the balls, the elastic member having a predetermined elasticity so as to be compressed or restored due to the shock applied to the balls; and
a case located external to the elastic member to position the elastic member so that the elastic member comes into contact with the outer ring.

2. The bearing as set forth in claim 1, wherein the balls are made of a highly heat-resistant material.

3. The bearing as set forth in claim 2, wherein the material of the balls is a ceramic material.

4. The bearing as set forth in claim 1, wherein the elastic member is a corrugated elastic plate formed by being multiply bent to have a serpentine pattern.

5. The bearing as set forth in claim 4, further comprising:
a shock-absorbing member attached to at least one of the inner and outer circumferences of the corrugated elastic plate.

6. The bearing as set forth in claim 1, wherein the case is perforated with a plurality of vent holes to introduce cooling air to the elastic member.
